(19) United States
(12) Patent Application Publication
(10) Pub. No.: US 2004/0015603 A1
(43) Pub. Date: Jan. 22, 2004

(54) Method of protecting the data transmission in a data bus

(75) Inventors: Robert Griessbach, Weyarn (DE); Martin Peller, Muenchen (DE)

Correspondence Address: CROWELL & MORING LLP, INTELLECTUAL PROPERTY GROUP, P.O. BOX 14300, WASHINGTON, DC, 20044-4300, US

(73) Assignee: Bayerische Motoren Werke Aktiengesellschaft

(21) Appl. No.: 10/128,547

(22) Filed: Apr. 24, 2002

Related U.S. Application Data
(63) Continuation of application No. PCT/EP00/10296, filed on Oct. 19, 2000.

(30) Foreign Application Priority Data
Oct. 25, 1999 (DE) 199 51 451.8

(51) Int. Cl. G06F 15/16

(52) U.S. Cl. 709/236

(57) ABSTRACT

The invention relates to a method for securing data transfer in a data bus via which data telegrams of at least one transmitter are transferred containing a data field of a variable length and a check sum and the data transfer quality is determined by the receiver using the check sum, said check having a shorter length when the data field length is shorter than when the data field is longer.

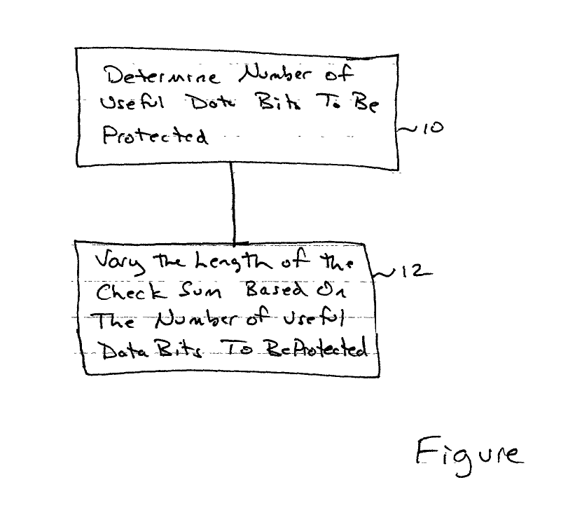

### CROSS-REFERENCE TO RELATED APPLICATIONS

This application is a continuation of PCT Application No. PCT/EP00/10296 filed Oct. 19, 2000.

### BACKGROUND AND SUMMARY OF THE INVENTION

The invention relates to a method for securing data transfer in a data bus via which data telegrams (messages, packets) of at least one transmitter are transmitted. The data telegrams contain a data field of a variable length and a check sum (CRC), in which case the data transmission quality is determined by the receiver using the check sum.

A method of this type is known from German Patent document DE 197 53 288 A. The check sum may be a parity check or a cyclic redundancy check.

The data telegram consists essentially of header data, the so-called header, for the identification of the transmitter and/or of the content of the data telegram, the actual (useful) data (data field, payload) and the check sum. The check sum is computed according to a defined formula from the data to be transmitted and is transmitted along with the useful data by way of the transmission medium, preferably constructed as a data bus. The receiver of the data also computes this check sum according to the same computation rule. If the two values do not correspond, this indicates a transmission disturbance, and the data can be identified as mutilated.

The length of the check sum depends on the number of the useful data bits to be protected and on the required transmission security, thus the Hamming distance. A large number of data bits to be protected, while the Hamming distance is the same, requires a longer check sum. In the case of data transmission protocols known today, the computing of the check sum takes place according to a fixed pattern, that is, the length of the check sum depends on the maximally possible number of data bits to be protected.

It is disadvantageous that, in the case of short data telegrams, the long check sum is also transmitted. This results in a constant telegram overhead which is independent of the number of useful data bits.

It is an object of the invention to reduce the telegram overhead, without losses in the transmission quality, to an absolutely necessary extent and, therefore, reduce the bus load as a result of the reduction of the telegram overhead.

The invention achieves this object by providing a method of protecting the data transmission in a data bus via which data telegrams of at least one transmitter are transmitted. The data telegrams contain a data field of a variable length and a check sum (CRC). The data transmission quality is determined by the receiver using the check sum. When the data field length is short, the check sum has a shorter length than in the case of a data field having a large length.

### BRIEF DESCRIPTION OF THE DRAWING

The FIGURE is a flow chart illustrating the principle of the present invention.

### DETAILED DESCRIPTION OF THE DRAWING

Referring to the FIGURE, the number of check sum bits 10 becomes dependent on the number of data bits to be protected 12 and thus on the telegram length. This creates the possibility of using, in the case of short telegrams, fewer check sum bits than in the case of longer telegrams. The same transmission security is achieved in both cases.

The decision of which formula to use in computing the check sum and thus for determining the used check sum bit number, can often be made already before the telegram is sent out. This is because, in the case of many protocols, information is also transmitted concerning the length of the telegram for a further protection.

This is illustrated by means of an example. It is assumed that a data telegram has a variable number of useful data bits with up to 31 bytes. This number is determined by the transmitter already before the start of its transmission and is transmitted along with the telegram as digital telegram length information LEN in the header data.

For up to 31 bytes of useful data content with the indicated grading of 1 byte, 5 bits are required for the purpose of the LEN information. The information LEN=00001 means that 1 byte of useful data is contained in the telegram; LEN=00010 or LEN=11111 indicate 2 and 31 bytes of useful data, respectively are contained in the telegram.

By means of the value of LEN, the number of check sum bits which results from the selected formula for computing the check sum can be predetermined. If, for example, two different numbers of check sum bits are used, e.g. 15 bits in the case of a number of useful data bits less than 18 data bytes and 24 bits for equal to or greater than 18 data bytes, then a reduction of the number of check sum bits from 24 to 15 bits occurs for data telegrams which have the indicated useful number of data bits below 18 data bytes.

By means of the invention, the protocol overhead in the case of data transmissions can be minimized.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for securing data transfer in a data bus via which data telegrams of at least one transmitter are transferred containing a data field having a variable length and a check sum, a data transfer quality being determined by a receiver using the check sum, the method comprising the acts of:
obtaining an indication of a data field length of a data telegram; and
providing a shorter check sum length when it is indicated the data field length is shorted than when the data field length is longer.

2. The method according to claim 1, wherein the check sum has two possible lengths.

3. The method according to claim 1, wherein the check sum length is determined by the transmitter using the data field length.

4. The method according to claim 2, wherein the check sum length is determined by the transmitter using the data field length.

5. The method according to claim 1, wherein the check sum length is determined by the transmitter using information on the data field length provided in the data telegram.

6. The method according to claim 2, wherein the check sum length is determined by the transmitter using information on the data field length provided in the data telegram.

7. A method for securing data transfer in a data bus via which data telegrams of at least one transmitter are transferred containing a data field having a variable length and a check sum, wherein a data telegram receives a variable length check sum such that a check sum having a shorter length is used when a data field length of the data telegram is shorter than when the data field length of the data telegram is longer.
